(19) United States
(12) Patent Application Publication
(10) Pub. No.: US 2024/0312112 A1
(43) Pub. Date: Sep. 19, 2024

(54) Systems and Methods for Efficient Compression of Low-Resolution Game Assets

(71) Applicant: Six Impossible Things for Breakfast Limited, Dublin (IE)

(72) Inventor: Sherry IGNATCHENKO, Weidling (AT)

(73) Assignee: Six Impossible Things Before Breakfast Limited, Dublin (IE)

(21) Appl. No.: 18/602,575

(22) Filed: Mar. 12, 2024

Related U.S. Application Data
(60) Provisional application No. 63/489,890, filed on Mar. 13, 2023.

(51) Int. Cl. G06T 15/04; A63F 13/30

(52) U.S. Cl. CPC G06T 15/04; A63F 13/30

(57) ABSTRACT

The systems and methods described herein provide techniques for constructing computer-generated three-dimensional objects to be rendered within a virtual scene. In various implementations, base meshes, base textures, and texture overlays may be stored on a client computer system and used to render a three-dimensional object based on instructions received from a game server. Each base mesh may correspond to a different shape for a given type of three-dimensional object. For example, the base mesh may be for a body type of a character, the base mesh may represent a body shape for the character, and the one or more textures may represent skin tone and/or one or more types of clothing to be rendered on the character. In various implementations, the client computer system may receive instructions from the game server in which the data needed to identify the three-dimensional object may be encoded using a single-digit number of bytes.

### RELATED APPLICATIONS

This application claims priority to U.S. Provisional Application No. 63/489,890, entitled “Method for Efficient Compression of Low-Level LOD Assets,” filed on Mar. 13, 2023, the content of which is hereby incorporated herein by reference in its entirety.

### FIELD OF THE DISCLOSURE

The systems and methods described herein relate to improved techniques for rendering computer-generated three-dimensional objects for video games.

### BACKGROUND

In computer graphics, different levels of detail are frequently used to express the complexity of computer-generated graphics or three-dimensional models. A “level of detail” (or “LOD”) can be described as one or more three-dimensional models, with a certain number of triangles or vertices used, and maybe a certain texture applied. Different LODs of the same three-dimensional object may have a different number of triangles/vertices, and different resolutions and/or image quality of the textures. The tradeoff when using LODs is in the quality of a rendered three-dimensional object versus resources needed to describe and/or render the three-dimensional object. For example, a lower or minimized LOD requiring less data may be used as a placeholder while a three-dimensional model for an object is still loading to improve the experience of the user. A lower or minimized LOD may also be used when the object appears further away from the camera within a virtual environment.

In three-dimensional online games, a virtual environment may include various three-dimensional objects, such as characters, items, cars, furniture, buildings, or other structures. Using lower LODs to render, for example, objects appearing further away within the virtual environment may reduce transmission data size, transmission time, and/or memory usage. In turn, using lower LODs may improve a game's response time, which is an essential factor in the playability of any game. As the complexity and scale of virtual environments in online games increases (for example, to accommodate the use of augmented or virtual reality), maintaining an adequate response time becomes increasingly difficult. Indeed, as the size of the files needed to render a virtual environment increases, so too does transmission data size, transmission time, and memory usage. Accordingly, improved techniques for rendering computer-generated three-dimensional objects are needed for online video games. For example, it would be an improvement if game assets rendered at lower LODs could be constructed based on descriptions comprising only a few bytes of data.

### SUMMARY OF THE DISCLOSURE

This disclosure relates to systems and methods for constructing computer-generated three-dimensional objects to be rendered within a virtual scene. According to an aspect of the invention, the systems and methods described herein may construct three-dimensional objects on a client computer system for rendering within a virtual scene using base meshes, base textures, and one or more texture overlays stored on the client computer system. In various implementations, the base meshes, base textures, and texture overlays used to render a three-dimensional model are received by the client computer system from a game server. In some implementations, each base mesh for a given type of three-dimensional object corresponds to a different shape for that type of three-dimensional object. The one or more types of three-dimensional objects may include, for example, one or more characters, items, cars, furniture, buildings, and/or one or more other types of three-dimensional objects. In various implementations, the set of base textures and the set of texture overlays associated with a given base mesh are UV-mapped to that base mesh. In an example implementation, the base mesh may be for a character, the base mesh may represent a body shape for the character, and the one or more textures may represent skin tone and/or one or more types of clothing to be rendered on the character. In various implementations, the one or more textures each comprise at least one transparent portion and at least one non-transparent portion. In other implementations, textures (or texture overlays) may be represented using vector graphics such as Scalable Vector Graphics (“SVG”).

According to another aspect of the invention, the client computer system may receive instructions from a game server to render a three-dimensional object within the virtual scene. In various implementations, the instructions may identify a base mesh of the stored base meshes, a base texture of a stored set of base textures associated with the identified base mesh, and one or more texture overlays of a stored set of texture overlays associated with the identified base mesh. In various implementations, the instructions may include a set of one or more bits to identify the base mesh, a set of one or more bits to identify the base texture, and a set of one or more bits to identify the one or more texture overlays. In various implementations, the data needed to identify the three-dimensional object may be encoded using a single-digit number of bytes. Based on the instructions received, a texture for a three-dimensional object may be constructed using the identified base texture and one or more texture overlays. The constructed texture may then be applied to the base mesh to render the three-dimensional object.

These and other objects, features, and characteristics of the systems and/or methods disclosed herein, as well as the methods of operation and functions of the related elements of structure and the combination thereof, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a block diagram of an example of a system configured to construct computer-generated three-dimensional objects to be rendered within a virtual scene, according to one or more aspects described herein; and

FIG. 2 depicts a flow diagram of an example of a method for constructing computer-generated three-dimensional objects to be rendered within a virtual scene, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and case of illustration, these drawings are not necessarily drawn to scale.

### DETAILED DESCRIPTION

Certain illustrative aspects of the systems and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

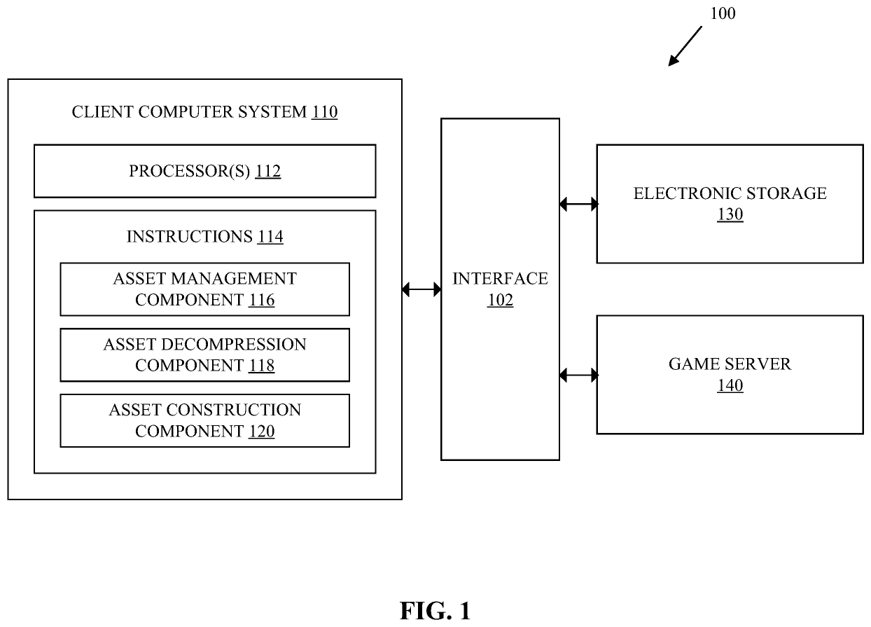

FIG. 1 illustrates an example of a system 100 configured to construct computer-generated three-dimensional objects to be rendered within a virtual scene, according to one or more aspects described herein. In various implementations, system 100 may include one or more of interface 102, a client computer system 110, electronic storage 130, a game server 140, and/or other components. In some implementations, client computer system 110 may be configured to receive instructions and game state data related to an online game comprising three-dimensional virtual scenes from game server 140. In various implementations, computer system 110 may include one or more physical processors 112 (also interchangeably referred to herein as processor(s) 112, processor 112, or processors 112 for convenience), computer readable instructions 114, and/or one or more other components. In some implementations, system 100 may include one or more external resources, such as sources of information outside of system 100, external entities participating with system 100, and/or other resources. In various implementations, system 100 may be configured to receive input from or otherwise interact with one or more users via client computer system 110 and/or game server 140.

In various implementations, physical processor(s) 112 may be configured to provide information processing capabilities in system 100. As such, the processor(s) 112 may comprise one or more of a digital processor, an analog processor, a digital circuit designed to process information, a central processing unit, a graphics processing unit, a microcontroller, a microprocessor, a field programmable gate array (FPGA), an application specific transformed circuit (ASIC), a System on a Chip (SoC), and/or other mechanisms for electronically processing information. Processor(s) 112 may be configured to execute one or more computer readable instructions 114. Computer readable instructions 114 may include one or more computer program components. In various implementations, computer readable instructions 114 may include one or more of an asset management component 116, an asset decompression component 118, an asset construction component 120, and/or other computer program components. As used herein, for convenience, the various computer readable instructions 114 will be described as performing an operation, when, in fact, the various instructions program the processor(s) 112 (and therefore system 100) to perform the operation.

In various implementations, asset management component 116 may be configured to create base meshes for three-dimensional objects that may be used to render the three-dimensional objects within a virtual scene. In other implementations, asset management component 116 may be configured to receive base meshes for three-dimensional objects from a game server and store the base meshes in a memory of client computer system 110. In either case, one or more base meshes may be created for three-dimensional objects such as characters, items, cars, furniture, buildings or other structures, and/or other generic objects that may be rendered within a virtual scene (or environment). In various implementations, base meshes may comprise low-poly meshes or meshes including a relatively small number of polygons. In such implementations, base meshes may comprise base meshes that may be used to render three-dimensional objects at lower LOD levels. For example, the base meshes may be used to render lower-resolution three-dimensional objects appearing further away within a virtual environment. In various implementations, each base mesh may be associated with unique mesh identification information. For example, the unique mesh identification information may comprise a mesh identifier that is used to identify a single base mesh.

In various implementations, each base mesh may correspond to a different shape for a given three-dimensional object. In an example implementation, asset management component 116 may be configured to create or receive base meshes for generic characters that may be rendered within a virtual scene. For example, asset management component 116 may be configured to create or receive base meshes for generic characters such as “normal male”, “tall male”, “short male”, “thin male”, “fat male”, “normal female”, “tall female”, “short female”, “thin female”, “fat female”, and/or one or more other types of generic characters. As described further herein, a texture to be applied to a base mesh may be constructed from a base texture and one or more texture overlays, and/or from vector graphics. For example, the base texture may represent a skin tone and the one or more texture overlays may represent different types of clothing. In some implementations, however, when clothing or other feature(s) significantly change the shape (or silhouette), an additional base mesh may instead be created for the object. For example, asset management component 116 may be configured to create or receive base meshes for generic characters having a special shape, such as “female wearing a long dress” or “male wearing a parka.”

In some embodiments, some of base meshes may be “morphable meshes,” which may contain “morph targets” (which may be interchangeably referred to herein as “blend shapes”), such that the same mesh may be used to represent more than one shape. For example, a single mesh may comprise one or multiple morph targets enabling it to be used to represent multiple shapes, and, in some embodiments, may allow morphs to be partially applied (e.g a first percentage corresponding to one shape and a second percentage corresponding to a different shape). In one non-limiting example embodiment, any combination of the “normal male”, “tall male”, “short male”, “thin male”, “fat male”, “normal female”, “tall female”, “short female”, “thin female”, and “fat female” may be represented by a single mesh with several morph targets (blend shapes). In other embodiments, there may be two meshes—“normal male” and “normal female”, with all non-gender-related attributes (“thin”, “tall”. “short”, etc.) implemented as morph targets (or blend shapes). In some embodiments, morph targets (or blend shapes) may allow partially applied morphs. For example, it may be possible to apply a certain percentage (e.g., 40%) of a morph target corresponding to “fat male” and combinations of morph targets, such as a “normal male” base mesh with 70% “fat male” and 30% “short male” morph targets applied, thereby allowing for the generation of a mesh corresponding to a rather fat, but a bit short, male).

In various implementations, asset management component 116 may be configured to create base textures that may be applied to a base mesh for a three-dimensional object. In other implementations, asset management component 116 may be configured to receive base textures that be applied to a base mesh from a game server and store the base textures in a memory of client computer system 110. In either case, multiple base textures may be created for each base mesh. Accordingly, each base mesh may be associated with a set of available base textures. In an example implementation, the base textures associated with base meshes for generic characters may comprise “naked” textures. In such implementations, these “naked” textures may represent a skin tone for the generic character. In some implementations, each base texture may be UV-mapped to one or more base meshes to which it is associated. In various implementations, each base texture may be associated with unique texture identification information. For example, the unique texture identification information may comprise a texture identifier that is used to identify a single base texture.

In various implementations, asset management component 116 may be configured to create texture overlays that may be combined with a base texture and applied to a base mesh for a three-dimensional object. In other implementations, asset management component 116 may be configured to receive texture overlays from a game server and store the texture overlays in a memory of client computer system 110. In either case, multiple texture overlays may be created for each base mesh or type of base mesh. Accordingly, each base mesh may be associated with a set of available texture overlays. In an example implementation, the texture overlays associated with base meshes for generic characters may represent different types of clothing. In such implementations, each texture overlay may be UV-mapped to one or more base meshes to which it is associated. In some implementations, texture overlays associated with one or more base meshes may be UV-mapped to the one or more base meshes using the same UV-mapping as base textures associated with those base meshes. In various implementations, each texture overlay may be associated with unique texture overlay identification information. For example, the unique texture overlay identification information may comprise a texture overlay identifier that is used to identify a single texture overlay.

In various implementations, textures and/or texture overlays may have multiple color channels (such as, for example, R,G,B or Y,Cb,Cr). In some implementations, an additional transparency channel (commonly known as alpha-channel) may be added. For example, an additional transparency channel (or alpha-channel) may be added as described in “Alpha compositing,” Wikipedia, The Free Encyclopedia, Feb. 13, 2024 (last visited Feb. 23 2024), available at https://en.wikipedia.org/wiki/Alpha_compositing.

In various implementations, texture overlays may have no meaningful color. Rather, only an alpha-channel may be used from texture overlays when constructing a three-dimensional object for rendering in a virtual scene. For example, in an example implementation, a texture overlay for a t-shirt may be fully non-transparent at pixels that correspond to points on a character mesh that a t-shirt would cover, and may be fully transparent at pixels that correspond to points on a character mesh that a t-shirt would not cover. In the foregoing example implementation, some pixels of the texture overlay may be partially transparent, for example, to provide some anti-aliasing. In various implementations, asset management component 116 may combine color (which may be come as a part of bitstream coming from game server 140, as described below), with the information from the alpha channel, to generate “colorized texture overlay” to be potentially applied to the texture, which then may be used for rendering of the three-dimensional object. For example, if we have the texture of a t-shirt with only its alpha channel being meaningful, and game server 140 indicates (via bitstream) that a yellow t-shirt (with RGB being (255,255,0)) is needed, asset management component 116 may generate a “colorized texture overlay,” consisting of all the pixels having the same RGB=(255,255,0), and alpha channel taken from the texture overlay of the t-shirt. Then, this “colorized texture overlay” may be a texture overlay not just of any t-shirt, but of a yellow t-shirt, which, when applied to the texture with subsequent rendering, may result in a rendering of a character wearing a yellow t-shirt.

In various implementations, asset management component 116 may be configured to store one or more base meshes for a three-dimensional object to be used to render the three-dimensional object within a virtual scene. In various implementations, asset management component 116 may be configured to store, in association with each of the one or more base meshes, a set of base textures and a set of texture overlays. A base mesh, a base texture, and one or more texture overlays may be used to render a three-dimensional object, such as a game asset rendered in virtual environment of an online three-dimensional game. In some implementations, base meshes, base textures, and texture overlays may be embedded into a decompressor, which in turn is embedded in a game client (such as client computer system 110). In some implementations, base meshes, base textures, and texture overlays may be common for some or all of the objects of a given type that may be rendered in a virtual scene. For example, base meshes, base textures, and texture overlays for characters to be rendered in a virtual scene may be common for some or all characters, regardless how many player characters (PCs) or non-player characters (NPCs) are in an online game.

In various implementations, asset decompression component 118 may be configured to receive, decompress, and decode a compressed bitstream received from a game server (e.g., game server 140) that describes a three-dimensional object to be rendered within a virtual scene. Notably, the term “bitstream” is used herein, but a person of ordinary skill in the art would understand that the term “bitstream” could be replaced wherever used herein with “bytestream,” “file,” or other terminology used to describe coded data or information. In various implementations, a compressed bitstream describing a three-dimensional object to be rendered within a virtual scene may be transferred over the Internet. In other words, client computer system 110 may receive the compressed bitstream from game server 140 via the Internet. In various implementations, a compressed bitstream describing a three-dimensional object to be rendered may include one or more bits to identify a base mesh, one or more bits to identify morph targets to be applied to the base mesh (and/or percentages to be applied), one or more bits to identify a base texture, and one or more bits to identify any texture overlays to be used to render the object and a color for each texture overlay. For example, to describe a character, a compressed bitstream may include a few bits representing an identifier of a base mesh and a few bits representing an identifier of a base texture (which may effectively encode skin tone). As necessary, the compressed bitstream may also include a few bits representing a type of top (which may correspond to an identifier for a texture overlay for a given top) that a character is wearing (such as a t-shirt, jacket, or other type of top), a few bits representing a color of the top, a few bits representing a type of bottom (or an identifier for a texture overlay for bottoms) that a character is wearing, a few bits representing a color of the bottoms, a few bits representing a color of the character's shoes, and/or a few bits representing a color of the character's hat. In some implementations, a compressed bitstream may encode a three-dimensional object to be rendered within a virtual scene using a single-digit number of bytes. Encoding a three-dimensional object using only a single-digit number of bytes is a significant improvement over traditional methods of representing low-level assets, which can often require thousands of bytes.

In some implementations, instead of being encoded in raw bits, identification of the base mesh, base texture, and one or more texture overlays to be used to render a three-dimensional object may be encoded within an intermediate symbol stream consisting of symbols. For example, identification of the base mesh, base texture, and one or more texture overlays to be used to render a three-dimensional object may be encoded into an intermediate symbol stream as described in U.S. patent application Ser. No. 18/438,702, entitled “SYSTEMS AND METHODS FOR IMPROVING COMPRESSION OF STRUCTURED DATA IN THREE-DIMENSIONAL APPLICATIONS,” filed Feb. 12, 2024, the content of which is hereby incorporated by reference herein in its entirety. For example, identifiers of the base mesh, base texture, and one or more texture overlays to be used to render a three-dimensional object may be encoded within an intermediate symbol stream using pre-defined symbols. In such implementations, frequency tables embedded within the compressor (on game server) and decompressor (e.g., asset decompression component 118) may be used to encode and decode symbols within the intermediate symbol stream. In some implementations, the percentages of morph targets (or blend shapes), color of the texture overlays, and/or other information to be used to render the three-dimensional object may also be encoded within the intermediate symbol stream using pre-defined symbols and/or may be incorporated into symbols used to encode the identification of the meshes and/or textures to which they correspond. In such implementations, the intermediate symbol stream may be compressed using one or more entropy coding methods. For example, the one or more entropy coding methods may comprise Huffman coding, arithmetic coding, one of the asymmetric numeral systems (ANS) family of entropy coding methods, and/or one or more other entropy coding methods. As referred to herein, the ANS family of entropy coding methods may include range asymmetric numeral systems (rANS), tabled asymmetrical numeral systems (tANS), finite state entropy (FSE), and/or one or more other similar entropy coding methods. The compressed intermediate symbol stream may also be referred to herein as the “compressed bitstream.”

In various implementations, colors for texture overlays (such as tops, bottoms, hats, shoes, and/or other portions of an object to be rendered within a virtual scene) may be encoded based on RGB components. For example, colors for textures may be encoded using RGB components such as 5-bit R, 5-bit G, and 5-bit B. In other implementations, colors for texture overlays may be encoded using bit(s) representing an identifier for a color within a table. For example, colors for texture overlays may be encoded using bit(s) representing an identifier for a color within a table that is embedded within a compressor (on game server) and decompressor (e.g., asset decompression component 118). In some implementations, standard color tables may be used, such as color tables listing 16 colors from CGA 16-color palette, 64 colors from EGA color palette, X11 named colors, HTML/CSS named colors, and/or other now known or future developed color sets.

In various implementations, asset construction component 120 may be configured to construct a three-dimensional object for rendering in a virtual scene based on the decoded bitstream. In various implementations, asset construction component 120 may be configured to obtain a base mesh and a base texture identified in the decoded bitstream. For example, one or more bits in the compressed bitstream may identify a base mesh, and one or more subsequent bits in the compressed bitstream may identify a base texture. In various implementations, asset construction component 120 may be configured to apply the base texture to the base mesh. In an example implementation, this may entail applying a texture to the base mesh that provides the base character mesh with skin of a specified skin tone. In various implementations, asset construction component 120 may also be configured to generate (or “bake”) a texture to be applied to the base mesh in lieu of the base texture.

In order to “bake” a texture, asset construction component 120 may be configured to obtain one or more texture overlays identified in the decoded bitstream. For example, one or more bits in the compressed bitstream may identify one or more texture overlays. For each texture overlay identified, asset construction component 120 may be configured to create a texture that is the same size as the texture overlay and that is the color encoded in one or more subsequent bits after the bits used to encode the texture overlay. In various implementations, asset construction component 120 may be configured to apply an alpha channel from the texture overlay to this created texture to generate a partially-transparent texture. In various implementations, asset construction component 120 may then be configured to overlay the partially transparent texture generated for each texture overlay over the base mesh. In one example, texture overlay may be applied simply as a transparent overlay, using its alpha channel to combine it with the existing texture. In another example, asset construction component 120 may be configured to generate a first partially-transparent “colorized texture overlay” based on a first texture overlay and having a color identified for the first texture overlay and generate a second partially-transparent “colorized texture overlay” based on a second texture overlay having a color identified for the second texture overlay. In an example implementation, the first partially-transparent texture may comprise a top for a character, and the second partially-transparent texture may comprise bottoms for a character. In each of the first partially-transparent texture and second partially-transparent texture, the portion that corresponds to the clothing it represents may be the non-transparent portion and the portion that corresponds to the rest of the character may be the transparent portion. In various implementations, asset construction component 120 may be configured to apply each “baked” texture (e.g., the first partially-transparent texture and the second partially-transparent texture) to the base mesh. Doing so, in the example implementation described above, may result in a character having a shape defined by the base mesh, a skin tone defined by the base texture, and clothing applied based on the one or more texture overlays specified. In some implementations, each texture overlay—and each corresponding partially-transparent texture (or “baked texture”)—may be applied to the base mesh using the same UV mapping used to apply the base texture to the base mesh.

In some implementations, vector graphics (such as SVG) may be used to produce base texture and/or texture overlays. In vector graphics, certain vectorized elements (which may, for example, correspond to a t-shirt or pants) may have their colors assigned. Such a vector representation may be (as with the textures discussed herein) stored on the client computer, and only color may be specified in the bitstream. Then, asset construction component 120 may take the color or colors identified in the bitstream, replace the color or colors specified in vector graphics with the colors identified in the bitstream, and render vector graphics into raster representation of necessary pixel size to produce texture overlay or the whole texture to be applied to the mesh for the purposes of three-dimensional rendering. Note that when using vector graphics, there is a choice as to whether or not to use texture overlays to produce final texture to be applied to the mesh. In some implementations, a bitstream received providing instructions for rendering a three-dimensional objects may specify a color for one texture for an article of clothing and another color for another texture for another article of clothing. In one non-limiting example implementation, SVG files may be stored on the client computer, with SVG <path> element describing shape of t-shirt on the texture, and having “fill” parameter specified as any color or not specified at all, and with SVG <polygon> element describing shape of pants, and also having “fill” parameter specified as any color or not specified at all. Then, when color bits in bitstream arrive which specify that it is necessary to render a character with yellow t-shirt and blue pants, asset construction component 120 may (a) replace or add “fill” parameter for the <path> element specifying t-shirt, to specify “yellow”, (b) replace or add “fill” parameter for the <polygon> element specifying pants, to specify “blue”, (c) render this modified SVG image (the one with replaced/added “fill” parameters) into rasterized representation, and (d) use this rasterized representation for three-dimensional rendering of the mesh.

In some implementations, normal maps associated with a given base mesh and/or base texture may also be embedded within the decompressor and used, for example, to improve the appearance of surface irregularities on the three-dimensional object. Each of the techniques described with respect to base textures and/or texture overlays may similarly be applied to normal maps. For example, each normal map may be associated with unique normal map identification information. For example, the unique normal map identification information may comprise a normal map identifier that is used to identify a normal map when constructing a three-dimensional object. As described herein, for example, with respect to base textures and texture overlays, identification of a normal map to be used to render a three-dimensional object may also be encoded using raw bits or and/or encoded within an intermediate symbol stream.

In some implementations, asset construction component 120 may be configured to use the techniques described herein to construct three-dimensional models comprising buildings, roads, walls, gates, and/or other structures. For example, asset construction component 120 may be configured to construct three-dimensional models using stored standard three-dimensional models as described in U.S. patent application No. 18/602,195, entitled “SYSTEMS AND METHODS FOR RUNTIME CONSTRUCTION OF THREE-DIMENSIONAL URBANISTIC LANDSCAPES,” filed Mar. 12, 2024, the content of which is hereby incorporated by reference herein in its entirety. In such implementations, asset construction component 120 may be configured to, for example, construct a “two-story building with three windows per row and 1 m between windows” in response to instructions indicating the foregoing. Using the techniques described herein, asset construction component 120 may also be configured to construct a “two-story building with three windows per row, 1 m between windows, white windows, and yellow walls.” In such an implementation, the number of stories of the building, the number of windows per row, the space between windows, the color of the windows (or window frames), the color of the walls, and/or one or more other features of the building may each be encoded using one or more bits as described herein with respect to asset decompression component 118. In order to add the “white windows” and “yellow walls,” asset construction component 120 may be configured to apply partially-transparent textures generated using texture overlays and/or using vector graphics as described herein. In some implementations, a single set of meshes may be used to produce a multitude of buildings that may be rendered within a virtual scene, including the foregoing example building, further reducing the requirement to have a slew of different meshes. In other implementations, individual meshes and textures from a set of stored meshes and textures may be obtained based on the individual bits in the compressed bitstream identifying a width and height of the building's façade and color of its parts. In either case, the amount of data necessary to describe the object is drastically reduced using the techniques described herein.

Electronic storage 130 may include electronic storage media that electronically stores and/or transmits information. The electronic storage media of electronic storage 130 may be provided integrally (i.e., substantially nonremovable) with one or more components of system 100 and/or removable storage that is connectable to one or more components of system 100 via, for example, a port (e.g., USB port, a Firewire port, and/or other port) or a drive (e.g., a disk drive and/or other drive). Electronic storage 130 may include one or more of optically readable storage media (e.g., optical disks and/or other optically readable storage media), magnetically readable storage media (e.g., magnetic tape, magnetic hard drive, floppy drive, and/or other magnetically readable storage media), electrical charge-based storage media (e.g., EPROM, EEPROM, RAM, and/or other electrical charge-based storage media), solid-state storage media (e.g., flash drive and/or other solid-state storage media), and/or other electronically readable storage media. Electronic storage 130 may be a separate component within system 100, or electronic storage 130 may be provided integrally with one or more other components of system 100 (e.g., computer system 110 or processor 112). Although electronic storage 130 is shown in FIG. 1 as a single entity, this is for illustrative purposes only. In some implementations, electronic storage 130 may comprise a plurality of storage units. These storage units may be physically located within the same device, or electronic storage 130 may represent storage functionality of a plurality of devices operating in coordination.

Electronic storage 130 may store software algorithms, information determined by processor 112, information received remotely, and/or other information that enables system 100 to function properly. For example, electronic storage 130 may store standard three-dimensional meshes or models, information relating to one or more three-dimensional meshes or models, one or more meshes, one or more textures, one or more normal maps, and/or other information related to the systems and methods described herein.

Game server 140 may comprise a remote server configured to provide instructions and game state data related to an online game comprising three-dimensional virtual scenes to client computer system 110. In some implementations, game server 140 may be configured to provide to client computer system 110 instructions related to an online game that include instructions to render a three-dimensional object within a virtual scene. For example, the instructions may include an instruction to construct a virtual scene comprising at least one object to be generated based on a base mesh, a base texture, and one or more texture overlay embedded or stored on client computer system 110. In various implementations, game server 140 may be configured as a server device (e.g., having one or more server blades, processors, etc.) and/or as another device capable of providing instructions and game state data related to an online game to client computer system 110.

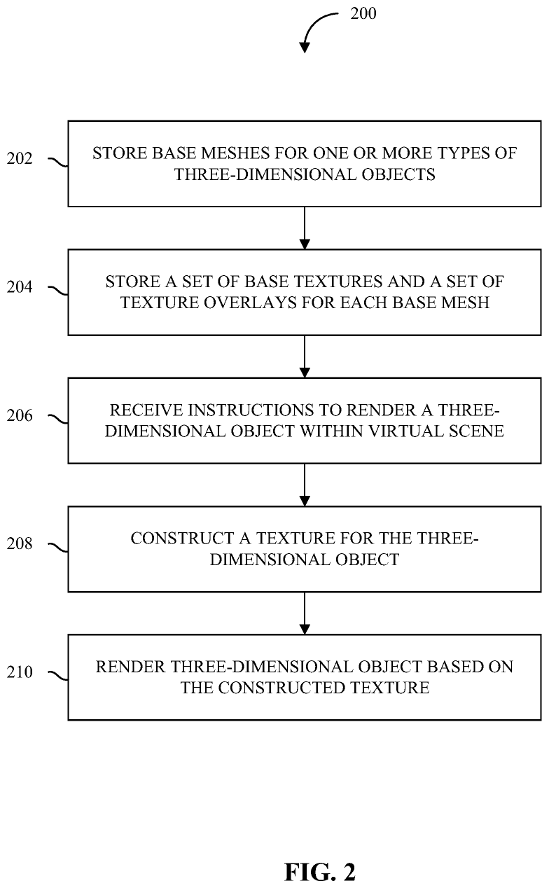

FIG. 2 illustrates an example of a process 200 for constructing on a client computer system a computer-generated three-dimensional object to be rendered within a virtual scene, according to one or more aspects described herein. The operations of process 200 presented below are intended to be illustrative and, as such, should not be viewed as limiting. In some implementations, process 200 may be accomplished with one or more additional operations not described, and/or without one or more of the operations discussed. In some implementations, two or more of the operations of process 200 may occur substantially simultaneously. The described operations may be accomplished using some or all of the system components described in detail above.

In an operation 202, process 200 may include storing base meshes for one or more types of three-dimensional objects to be used to render three-dimensional objects within a virtual scene. In various implementations, the base meshes are received by the client computer system from a game server. In some implementations, each base mesh for a given type of three-dimensional object corresponds to a different shape for that type of three-dimensional object. The one or more types of three-dimensional objects may include, for example, one or more characters, items, cars, furniture, buildings, and/or one or more other types of three-dimensional objects. In some implementations, operation 202 may be performed by a processor component the same as or similar to asset management component 116 (shown in FIG. 1 and described herein). In some implementations, base meshes may include “morphable meshes,” as described herein.

In an operation 204, process 200 may include storing a set of base textures and/or a set of texture overlays for each of the stored base meshes for the one more types of three-dimensional objects. In various implementations, the set of base textures and the set of texture overlays associated with a given base mesh are UV-mapped to that base mesh. In an example implementation, the base mesh may be for a character, the base mesh may represent a body shape for the character, and the one or more textures may represent skin tone and/or one or more types of clothing to be rendered on the character. In various implementations, the one or more texture overlays each comprise at least one transparent portion and at least one non-transparent portion. In some implementations, operation 204 may be performed by a processor component the same as or similar to asset management component 116 (shown in FIG. 1 and described herein). In some embodiments, some or all of the textures and/or texture overlays may be defined using vector graphics (such as, for example, SVG).

In an operation 206, process 200 may include receiving instructions from a game server to render a three-dimensional object within the virtual scene. In various implementations, the instructions may identify a first base mesh of the stored base meshes, a base texture of a stored set of base textures associated with the first base mesh, and one or more texture overlays of a stored set of texture overlays associated with the first base mesh. In various implementations, the instructions may include a first set of one or more bits to identify the first base mesh, a second set of one or more bits to identify the base texture, and a third set of one or more bits to identify the one or more texture overlays. In some implementations, the first set of one or more bits may encode a mesh identifier for the first base mesh, the second set of one or more bits may encode a texture identifier for the base texture, and the third set of one or more bits may encode a texture overlay identifier for each of the one or more texture overlays. In some implementations, additional bits or intermediate symbols may be present in the instructions to denote morph targets (or blend shapes) to be applied to the mesh and/or their respective percentages as described herein. In various implementations, the instructions may include one or more bits encoding a color of at least one of the one or more texture overlays. In some implementations, the color of the at least one texture overlay (and/or color of an element of the vector graphics) may be encoded as RGB components. In various implementations, the data needed to identify the three-dimensional object may be encoded using a single-digit number of bytes. In various implementations, the instructions may be transmitted from the game server to the client computer system over the Internet. In some implementations, operation 206 may be performed by a processor component the same as or similar to asset decompression component 118 (shown in FIG. 1 and described herein).

In an operation 208, process 200 may include constructing (“baking”) a texture for a three-dimensional object based on the identified base texture and the identified one or more texture overlays. In various implementations, the base texture and one or more texture overlays identified from the instructions may be obtained used to generate a texture to be applied to the base mesh to construct the three-dimensional object. For example, for each texture overlay to be used to render a three-dimensional object, the partially transparent texture overlay may be applied over the base texture and base mesh to generate the three-dimensional model. In some implementations, colors may be applied to the texture overlays and/or elements of the vector graphics, as described herein. In some implementations, operation 208 may be performed by a processor component the same as or similar to asset construction component 120 (shown in FIG. 1 and described herein).

In an operation 210, process 200 may include rendering the three-dimensional object based on the instructions, wherein the three-dimensional object comprises the texture applied to the first base mesh. In various implementations, the three-dimensional object may be rendered in a virtual scene based on the instructions. In some implementations, operation 210 may be performed by a processor component the same as or similar to asset construction component 120 (shown in FIG. 1 and described herein).

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific example aspects and implementations of the disclosure, and performing certain actions.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application-such as by using any combination of digital processors, analog processors, digital circuits designed to process information, central processing units, graphics processing units, microcontrollers, microprocessors, field programmable gate arrays (FPGAs), application specific transformed circuits (ASICs), a System on a Chip (SoC), and/or other mechanisms for electronically processing information—but such implementation decisions should not be interpreted as causing a departure from the scope of the present invention.

The description of the functionality provided by the different computer-readable instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the computer-readable instructions.

The various instructions described herein may be stored in electronic storage, which may comprise random access memory (RAM), read only memory (ROM), and/or other memory. In some implementations, the various instructions described herein may be stored in electronic storage of one or more components of system 100 and/or accessible via a network (e.g., via the Internet, cloud storage, and/or one or more other networks). The electronic storage may store the computer program instructions (e.g., the aforementioned instructions) to be executed by processor(s) 112 as well as data that may be manipulated by processor(s) 112. The electronic storage may comprise floppy disks, hard disks, optical disks, tapes, or other storage media for storing computer-executable instructions and/or data.

Although illustrated in FIG. 1 as a single component, client computer system 110 and game server 140 may each include a plurality of individual components (e.g., computer devices) each programmed with at least some of the functions described herein. In this manner, some components of client computer system 110 and/or associated client computing device(s) may perform some functions while other components may perform other functions, as would be appreciated. Furthermore, it should be appreciated that although the various instructions are illustrated in FIG. 1 as being co-located within a single processing unit, in implementations in which processor(s) 112 include multiple processing units, one or more instructions may be executed remotely from the other instructions.

Although client computer system 110, electronic storage 130, and game server 140 are shown to be connected to interface 102 in FIG. 1, any communication medium may be used to facilitate interaction between any components of system 100. One or more components of system 100 may communicate with each other through hard-wired communication, wireless communication, or both. In various implementations, one or more components of system 100 may communicate with each other through a network. For example, client computer system 110 may wirelessly communicate with electronic storage 130. By way of non-limiting example, wireless communication may include one or more of radio communication, Bluetooth communication, Wi-Fi communication, cellular communication, infrared communication, or other wireless communication. Other types of communications are contemplated by the present disclosure.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered example only, and the scope of the invention is accordingly intended to be limited only by the following claims.

What is claimed is:

1. A computer-implemented method of constructing computer-generated three-dimensional objects to be rendered within a virtual scene, the method comprising:
storing, by a client computer system, base meshes for one or more types of three-dimensional objects to be used to render three-dimensional objects within a virtual scene;
storing, by the client computer system, a set of base textures and a set of texture overlays for each of the base meshes for the one more types of three-dimensional objects;
receiving, by the client computer system from a game server, instructions to render a three-dimensional object within the virtual scene, wherein the instructions identify a first base mesh of the stored base meshes, a base texture of a stored set of base textures associated with the first base mesh, and one or more texture overlays of a stored set of texture overlays associated with the first base mesh;
constructing, by the client computer system, a texture for the three-dimensional object based on the identified base texture and the identified one or more texture overlays; and
rendering, by the client computer system, the three-dimensional object based on the instructions, wherein the three-dimensional object comprises the texture applied to the first base mesh.

2. The computer-implemented method of claim 1, wherein the base meshes, the base textures, and the texture overlays are received by the client computer system from a game server.

3. The computer-implemented method of claim 1, wherein each base mesh for a given type of three-dimensional object corresponds to a different shape for that type of three-dimensional object.

4. The computer-implemented method of claim 1, wherein the one or more types of three-dimensional objects include one or more of characters, items, cars, furniture, and buildings.

5. The computer-implemented method of claim 1, wherein the set of base textures and the set of texture overlays associated with a given base mesh are UV-mapped to that base mesh.

6. The computer-implemented method of claim 1, wherein the three-dimensional object comprises a character, the base mesh represents a body shape for the character, and the one or more texture overlays represent skin tone and/or one or more types of clothing to be rendered on the character.

7. The computer-implemented method of claim 1, wherein the instructions include a first set of one or more bits to identify the first base mesh, a second set of one or more bits to identify the base texture, and a third set of one or more bits to identify the one or more texture overlays.

8. The computer-implemented method of claim 7, wherein the first set of one or more bits encodes a mesh identifier for the first base mesh, the second set of one or more bits encodes a texture identifier for the base texture, and the third set of one or more bits encodes a texture overlay identifier for each of the one or more texture overlays.

9. The computer-implemented method of claim 7, wherein data needed to identify the three-dimensional object is encoded using a single-digit number of bytes.

10. The computer-implemented method of claim 1, wherein the instructions are transmitted from the game server to the client computer system over the Internet.

11. The computer-implemented method of claim 1, wherein the instructions include one or more bits encoding a color of at least one of the one or more texture overlays.

12. The computer-implemented method of claim 11, wherein the color of the at least one texture overlay is encoded as RGB components.

13. The computer-implemented method of claim 1, wherein the one or more texture overlays each comprise at least one transparent portion and at least one non-transparent portion.

14. A system for constructing computer-generated three-dimensional objects to be rendered within a virtual scene, the system comprising:
one or more processors configured by computer readable instructions to:
store base meshes for one or more types of three-dimensional objects to be used to render three-dimensional objects within a virtual scene;
store a set of base textures and a set of texture overlays for each of the base meshes for the one more types of three-dimensional objects;
receive, from a game server, instructions to render a three-dimensional object within the virtual scene, wherein the instructions identify a first base mesh of the stored base meshes, a base texture of a stored set of base textures associated with the first base mesh, and one or more texture overlays of a stored set of texture overlays associated with the first base mesh;
construct a texture for the three-dimensional object based on the identified base texture and the identified one or more texture overlays; and
render the three-dimensional object based on the instructions, wherein the three-dimensional object comprises the texture applied to the first base mesh.

15. The system of claim 14, wherein the base meshes, the base textures, and the texture overlays are received by the client computer system from a game server.

16. The system of claim 14, wherein each base mesh for a given type of three-dimensional object corresponds to a different shape for that type of three-dimensional object.

17. The system of claim 14, wherein the one or more types of three-dimensional objects include one or more of characters, items, cars, furniture, and buildings.

18. The system of claim 14, wherein the set of base textures and the set of texture overlays associated with a given base mesh are UV-mapped to that base mesh.

19. The system of claim 14, wherein the three-dimensional object comprises a character, the base mesh represents a body shape for the character, and the one or more texture overlays represent skin tone and/or one or more types of clothing to be rendered on the character.

20. The system of claim 14, wherein the instructions include a first set of one or more bits to identify the first base mesh, a second set of one or more bits to identify the base texture, and a third set of one or more bits to identify the one or more texture overlays.

21. The system of claim 20, wherein the first set of one or more bits encodes a mesh identifier for the first base mesh, the second set of one or more bits encodes a texture identifier for the base texture, and the third set of one or more bits encodes a texture overlay identifier for each of the one or more texture overlays.

22. The system of claim 20, wherein data needed to identify the three-dimensional object is encoded using a single-digit number of bytes.

23. The system of claim 14, wherein the instructions are transmitted from the game server to the client computer system over the Internet.

24. The system of claim 14, wherein the instructions include one or more bits encoding a color of at least one of the one or more texture overlays.

25. The system of claim 24, wherein the color of the at least one texture overlay is encoded as RGB components.

26. The system of claim 14, wherein the one or more texture overlays each comprise at least one transparent portion and at least one non-transparent portion.
